(19) United States
(12) Patent Application Publication
(10) Pub. No.: US 2008/0234458 A1
(43) Pub. Date: Sep. 25, 2008

(54) POLYOL AND METHOD OF MAKING POLYOL USING SOY-BASED POWDER

(76) Inventor: Richard A. West, Lakewood, OH (US)

Correspondence Address: FAY SHARPE LLP, 1100 SUPERIOR AVENUE, SEVENTH FLOOR, CLEVELAND, OH, 44114, US

(21) Appl. No.: 12/052,501

(22) Filed: Mar. 20, 2008

Related U.S. Application Data
(60) Provisional application No. 60/919,100, filed on Mar. 20, 2007.

(51) Int. Cl. C08G 18/00; C08G 65/34

(52) U.S. Cl. 528/85; 528/425

(57) ABSTRACT

A method is provided for preparing a polyol from a soy-based precursor powder wherein the powder exhibits excellent solubility as compared to soy polyols in the oil form, and a process for the use of the soy-based polyol thus prepared for the further preparation of polyurethane.

This application claims the priority benefit of, and expressly incorporates herein by reference, U.S. provisional application Ser. No. 60/919,100, filed Mar. 20, 2007.

### BACKGROUND OF THE INVENTION

The present invention relates generally to the use of a soy-based powder to generate a polyol. Specifically, the invention relates to the use of a soy-based precursor powder suitable for mixing with an aqueous or other solvent and used in place of conventional polyols.

By general definition, a polyol is a polyhydric alcohol including three or more hydroxyl groups. Those with three hydroxyl groups are glycerols and those with more than three are commonly called sugar alcohols and have the general formula CH₂OH(CHOH)ₙCH₂OH, where n may be from 2 to 5. Polyols find particular relevance with regard to the preparation and production of polyurethane products.

A polyurethane is made by mixing together an isocyanate and a polyol in a predetermined proportion. This generates a thermoplastic polymer, which can then be made into a thermosetting polymer, produced by the condensation reaction of the polyisocyanate and the polyol or the hydroxyl-containing material. Given the basic building blocks of the polyurethane, they can be tailored to generate materials which vary in properties including, among others, high elastic modulus, good electrical resistance, moisture resistance, excellent hardness, gloss, flexibility, abrasion resistance, adhesion, weather resistance, chemical resistance, and thermal conductivity.

Polyurethanes may be supplied in the form of fiber, coatings elastomers and foams. Of particular interest herein are polyurethanes in the form of sprayed foams. It will be apparent to the skilled artisan, however, that the attributes that make the subject inventive disclosure applicable to sprayed foams applies equally to all classes of polyurethanes. Fiber polyurethanes are used in textile products requiring exceptional elasticity and, for example, in bristles for brushes. Polyurethanes for coatings find applications in baked coatings, wire coatings, painted linings, maintenance paints, and masonry coatings. Those polyurethanes in the form of elastomers may find particular use as sealants and caulking agents, adhesives, films and linings, encapsulation for electronic parts, binders for rocket propellants, abrasive wheels and other mechanical items, auto bumpers, fenders and other components. Finally, polyurethanes suitable for use as foams may be flexible, such as those based on polyoxypropylene-diols, having a molecular weight of 2,000 and triols having a molecular weight of 4,000, or they may be rigid foams based on polyethers made from sorbitol, methylglucacide, or sucrose. Uses for foam-type polyurethanes include furniture, mattresses, laminates and linings, floor leveling, seat cushions and other automotive accessories, carpet underlay, upholstery, absorbants for crude oil spills on sea water, packaging and packing materials, building insulation, marine flotation, sound proofing, ship building, transportation insulations for box cars, refrigerated cars, hopper cars, trucks and trailers, insulation for storage tanks, ships hulls and pipelines, and auto bumpers. The foregoing is merely exemplary and by no means intended to be an exclusive list of potential applications for these materials.

The form of the polyurethane and the specific use therefore depends greatly on the polyisocyanate and polyol used, the precise ratio of these components to one another, other ingredients or components that may be added, and the processing parameters employed. Generally, the components are combined in liquid form and as the liquid mixes, which is an exothermic reaction, the mixture becomes increasingly viscous and eventually forms a solid mass.

There are many commercial grades of isocyanates that may be used for making polyurethane. Each grade gives different properties to the end product, requires different curing systems, and in most cases requires different processing parameters. An important property to be considered in choosing an isocyanate is the functionality, or the number of isocyanate groups (—NCO) per isocyanate molecule. Some of the more common isocyanates used in making polyurethanes include MDI (diphenolmethane 4,4-diisocyanate), NDI (naphthalene 1,5-diisocyanate), TDI (toluene diisocyanate), and HDI (hexamethylene diisocyanate). For example, flexible foam is generally made with TDI. The most widely used isocyanate for producing polyurethanes is MDI, which exhibits a functionality of about 2.8.

There are two main types of polyols used in the production of polyurethanes. These are polyethers and polyesters. For example, polyethylene adipate is a commonly used polyester, and poly(tetramethylene ether)glycol is a commonly used polyether. Of the polyethers that can be used, those most commonly used are polyethers having a relatively low molecular weight, ranging from 500 to 3,000, and that are manufactured from propylene oxide and ethylene oxide units. The functionality of a polyether polyol can be varied and is normally 2 for elastomer polyurethanes, approximately 3 for flexible foam polyurethanes, and up to 6 or more for rigid foam polyurethanes. Polyester polyols are typically produced by the condensation reaction of a diol, such as ethylene glycol, with a dicarboxylic acid. Polyester polyols tend to be more expensive and usually viscous and difficult to handle, however, they develop polyurethanes with superior tensile, abrasion, flex and oil resistant properties. Polyester polyurethanes, however, suffer from low hydrolysis resistance. Given that the polyesters tend to be more expensive, but also to have better properties, it is common to use a combination of polyols to achieve a desired outcome. In addition to the polyol, and isocyanate, the polyurethane may further contain additives, such as catalysts, chain extenders, flow agents, flame retardants, pigments, surfactants, fillers, and other such additives.

Historically, the polyol components of a polyurethane have been at least partial petroleum-based polyols. However, those industries employing polyurethanes, like many other industries, are facing serious environmental concerns. In an effort to respond to these concerns, polyols that have previously been petroleum-based have been replaced by what are commonly called “green” components. The term “green” as used herein refers to components which are environmentally friendly. In the context of polyols, such components might include castor oil and soy oil. However, even though this type of component is responsive to the environmental concerns posed by some polyols, it nonetheless has drawbacks of its own. One of the most pronounced drawbacks to the use of, for example, soy oil instead of more conventional polyols is the difficulty of keeping the soy polyol in suspension before and during processing. Therefore, it is desirable to provide a polyol source which is green and responds to the difficulties of maintaining oil-based polyols in suspension.

### SUMMARY OF THE INVENTION

In general, the present invention provides a method for preparing a polyol from a soy-based precursor powder, the powder exhibiting increased solubility over soy oil polyols.

In one aspect of the invention, therefore, there is provided a method for preparing a polyol from a soy-based precursor powder wherein the powder exhibits excellent solubility as compared to soy polyols, in the oil form.

In another aspect of the present invention, there is provided a method for the preparation of polyurethane from a combination of an isocyanate and a polyol prepared from a soy-based precursor powder.

Still other features and benefits of the invention will become apparent to those skilled in the art upon reading and understanding the following detailed description.

### DETAILED DESCRIPTION OF THE INVENTION

In an embodiment of the present invention, there is provided a method for the preparation of a liquid or aqueous-based polyol from a soy-based precursor powder. As is set forth above, certain polyols have fallen out of favor for use in industries where environmental concerns require the use of green components to produce green products. One specific example of this situation is the preparation of polyurethane products and materials. In preparing such materials, a chosen polyisocyanate-polyol system is combined in a liquid form. These components, optionally along with other additives, undergo an exothermic reaction to produce a polyurethane. During this reaction the liquid mixture become increasingly viscous and eventually forms a solid mass. Depending on the particular isocyanate-polyol system, and the ratio of the base components of the system, the resulting product may be produced in the form of a fiber, a coating, an elastomer, or a flexible or rigid foam.

Of particular interest herein is the production of sprayable, rigid foam. Such foams find application in the building industry as roofing material and as sprayed-in insulation, as well as in many other industrial applications.

In one embodiment of the invention, the polyurethane is comprised of about a 1 to 1 ratio mix of polyisocyanate to polyol. The system is generally referred to as having an A side (isocyanate) and a B side (polyol). The polyisocyanate, or A side, of choice for this particular application is diphenylmethane 4,4-diisocyanate or MDI, though other isocyanates may be used. The polyol, or B side, for use in this application is a polyol prepared from a soy-based precursor powder and an aqueous solvent. In addition to the polyol, the B side components further include a fire retardant, a blowing agent, a surfactant, a smoke retardant, a flame retardant, a cell opener, and one or more catalysts. Table I sets forth the A and B side components for a specific polyurethane system, intended for use as a low density insulation material.

TABLE I

| Polyurethane | | Fraction % | Parts/wt % |
|---|---|---|---|
| A-side | Isocyanate: MDI¹ | | 102.39 |
| B-side | | | 100/ |
| | Polyol: | | |
| | Aluminum trihydrate⁴ | 9.46 | |
| | PCF Phosphate⁵ | 28.51 | |
| | Water⁶ | 16.69 | |
| | Siltick 2740⁷ | 1.67 | |
| | BZ 54⁸ | 31.99 | |
| | Ortegal 500⁹ | 1.25 | |
| | Soy-based aqueous polyol² | 3.06 | |
| | DMEA³ | 2.36 | |
| | ADD. 108³ | 4.17 | |
| | CAT-41³ | 0.83 | |
| Total wt % | | | 100% |

¹MDI = diphenylmethane 4,4-diisocyanate
²Soy-based aqueous polyol prepared from soy powder and H₂O
³Catalyst = may be one or a combination of catalysts.
⁴powder fire retardant
⁵liquid fire retardant
⁶blowing agent
⁷Silicone surfactant
⁸Non-reactive bromine flame/smoke retardant
⁹Cell opener

In the foregoing formulation, the A side contains 31.50% available NCO functionality. On the B side, the water provides 6300 OH value, the BZ-54 provides 180 OH value, the soy polyol provides 28 OH value, and the CAT-41 provides 120 OH value. The A:B ratio for this mixture is 102.39 parts: 100 parts. The ratio of water to soy in the B side mixture is about 6 parts to 1 part.

With regard to the B-Side components, fire retardants may optionally be used and take the form of powder or fluid. For example, aluminum trihydrate is a powder flame retardant, and the phosphate fire retardant is added in the liquid form. In the above formulation, the powder fire retardant may be added as up to about 50% of the B side formulation, while the phosphate may be used as between about 5% and 20% of the B side formulation. Additionally, a flame and/or smoke retardant may be included as up to 40% of the mixture. An example of this material is a non-reactive bromine compound.

The blowing agent, which in the above instance is nothing more than water, converts the carbon in the isocyanate component to carbon dioxide which creates bubbles and helps to form the structure of the foam. In addition to water, other suitable blowing agents include pentane and 245 FA. This component may be added as up to about 60% of the B side mixture. In conjunction with the blowing agent, a cell opener, which functions to open the cells of the bubbles, allowing air to enter the interior voids before the carbon dioxide escapes, may be added as from about 0.0% to about 2% of the mixture. The cell opener prevents the polyurethane from shrinking down and helps it maintain its form.

Another component that may be included is a surfactant, such as a silicone compound. This component may be added as from about 0.5% to about 3% of the mixture, depending on the system

Catalysts may be added at levels needed for various environmental conditions in amounts from about 5% to about 10% of the B side formulation. There may be one catalyst used, or a combination of catalysts may be used.

In addition to the foregoing, pigments and other fillers may be added. Each additive, the type used and the amount employed is determined on a system-by-system basis, depending on the isocyanate and polyol chosen, the required properties for the end product, and the processing parameters employed.

As is stated hereinabove, while this particular polyurethane mixture finds application in sprayed-in-place roofing and insulation, the same type of polyurethane system, using a soy-based precursor powder polyol, will find equal application in cushion material, in construction applications of various sorts, in insulation and flotation for spas and boats, and in many other applications.

In practice, the A and B sides are mixed in a conventional polymer reactor. The B side, or polyol, may include any of the additives mentioned in Table 1, or any others known to the skilled artisan. It may also be useful to blend the B side components and then contact that mixture with the A side isocyanate component. Depending on the type of polyurethane being prepared, the mix, once reacted, may be blown/sprayed, molded, or otherwise worked for a specific purpose.

The soy-based precursor powder is an all natural soy (i.e., about 97% fat free). The soy-based polyol, prepared from the soy powder precursor, imparts many advantages to the preparation of a polyurethane. As has been mentioned above, the processing and product are green, as compared to products prepared using less environmentally friendly polyols. In addition, the chemistry of the soy protein allows for the addition of certain groups at open sites on the molecules to enhance specific performance characteristics. For example, fire retardants, and the like may be grafted or bonded right on to the protein. In this manner, the strength, flexibility, abrasion resistance, thermal properties, and others may be specifically tailored to achieve certain results. In addition to advantages of this type, there is also a considerable cost advantage to use of the soy-based powder to generate the polyol. Using conventional polyols, the foam polyurethane prepared herein may cost anywhere from $0.70 to $0.90/pound. Using the soy-powder precursor to prepare the polyol, the cost is reduced to less than $0.12/pound. Further, it is seen that very little of the actual polyol need be included, only 3.06% of the mixture.

The invention has been described with reference to the preferred embodiment. Clearly the advantages and benefits range from environmental, to chemical processing and product parameters, to cost efficiency. Modifications and alterations will occur to others upon reading and understanding this specification. It is intended to include all such modifications and alterations in so far as they come within the scope of the appended claims or the equivalents thereof.

Having thus described the invention, it is now claimed:

1. A method for making a polyol useful in preparing a polyurethane comprising:
mixing a soy-based precursor powder with a solvent, the soy-based precursor powder having increased solubility as compared to a soy oil polyol.

2. The method of claim 1 wherein the solvent is water.

3. The method of claim 1 wherein the soy-based precursor powder is about 97% fat free.

4. The method of claim 1 wherein the ratio of soy-based precursor powder to water is about 6 parts:1 part.

5. A process for the preparation of polyurethane comprising the steps of:
providing an A side component comprising an isocyanate;
providing a soy-based precursor powder;
mixing a soy-based precursor powder with a solvent to produce a polyol as a B side component;
reacting the A side component and B side component to form a polyurethane.

6. The process of claim 5 wherein the A side component is MDI, NDI, TDI or HDI.

7. The process of claim 5 wherein the polyurethane is comprised of about a 1 to 1 ratio mix of polyisocyanate to polyol.

8. The process of claim 5 wherein the soy-based precursor powder is about 97% fat free.

9. The process of claim 5 wherein the solvent is water.

10. The process of claim 5 where the B side component further comprises up to about 50% of one or more fire retardants.

11. The process of claim 5 wherein the B side component further comprises from about 0.5% to about 3% of one or more surfactants.

12. The process of claim 5 wherein the B side component further comprises up to about 60% of a blowing agent.

13. The process of claim 5 wherein the B side component further comprises one or more cell openers.

14. The process of claim 5 wherein the B side component further comprises up to about 10% of one or more catalysts.

15. The process of claim 5 wherein the A side to B side ratio is about 102 parts:100 parts.

16. The process of claim 5 wherein the B side component further comprises one or more surfactants, blowing agents and catalysts.
